(19) United States
(12) Patent Application Publication
(10) Pub. No.: US 2023/0316361 A1
(43) Pub. Date: Oct. 5, 2023

(54) METHOD AND APPARATUS FOR PROVIDING USER-CUSTOMIZED COFFEE RECIPE AND COFFEE CORRESPONDING TO THE SAME

(71) Applicant: Huzen GFC, Inc, Santa Clara, CA (US)

(72) Inventors: Jeongtae KIM, Santa Clara, CA (US); Hyuk KIM, Gyeonggi-do (KR); Ja Euk KOO, Gangwon-do (KR)

(73) Assignee: Huzen GFC, Inc, Santa Clara, CA (US)

(21) Appl. No.: 18/127,431

(22) Filed: Mar. 28, 2023

(30) Foreign Application Priority Data
Mar. 29, 2022 (KR) 10-2022-0038902

(51) Int. Cl. G06Q 30/0601; G06Q 30/0208; G06Q 30/0204; G06Q 30/0203; G06Q 20/38; G06Q 20/36

(52) U.S. Cl. CPC G06Q 30/0621; G06Q 30/0208; G06Q 30/0631; G06Q 30/0205; G06Q 30/0203; G06Q 20/389; G06Q 20/3678

(57) ABSTRACT

A method and apparatus for providing a user-customized coffee recipe and coffee corresponding to the same relates to a method of operating a server, through which one or more recommended recipes are provided to a user requesting a coffee based on a plurality of coffee recipes provided by users participating in a service, the user watches an advertising video for a determined recipe of his/her choice, and then a quick response (QR) code that allows the user to receive the coffee of the determined recipe from a coffee shop associated with the server offline is provided, and a server device. The method and apparatus enable consumers to receive coffees based on their own recipes regardless of time and place and can encourage users to create coffee recipes, share profits, and provide customized recommendations to other users, and provide a coffee service on a metaverse platform linked to an actual user.

### CROSS-REFERENCE TO RELATED APPLICATION

This application claims priority to and the benefit of Korean Patent Application No. 10-2022-0038902, filed on Mar. 29, 2022, the disclosure of which is incorporated herein by reference in its entirety.

### BACKGROUND

### 1. Field of the Invention

The present invention relates to a method and apparatus for providing a user-customized coffee recipe and coffee corresponding to the same. Specifically, the present invention relates to a method of operating a server, through which one or more recommended recipes are provided to a user who requests a coffee on the basis of a plurality of coffee recipes provided by users participating in a service, the user watches an advertising video for a determined recipe of his/her choice, and then a quick response (QR) code that allows the user to receive a coffee of the determined recipe from a coffee shop associated with the server offline is provided, and a server device.

### 2. Discussion of Related Art

Recently, the coffee industry, which directly roasts and provides coffee from green beans, has been developing not only in Korea but also around the world. As the coffee market grows, consumers' tastes are becoming more and more specialized, and thus there is a problem in that consumers' tastes cannot be met by uniformly classifying the origins of green beans or roasting the green beans. In addition, as consumers' knowledge about coffee deepens, consumers have a desire to determine a roasting operation, a blending ratio, or the like according to their tastes and to be provided with coffee customized to their recipes regardless of time and place. Therefore, there is a need for a method and apparatus for enabling consumers to receive coffees based on their own recipes regardless of time and place.

When recipes that are provided by participating users are shared together with recipe provider information through blockchains, it is possible to inform the users of who the recipe originates from, and thus it is possible to provide the users with an effect similar to the publication of intellectual property rights. Further, when some of the revenue for advertisements that users have to watch to drink coffee for free is provided based on a ratio selected by other users for recipes provided by participating users, it is possible to motivate the users to create and provide their own recipes. Further, when it is possible to recommend recipes that are mapped similarly to information of a user who has requested coffee by generating preference statistics according to the user's nationality, region, age, sex, etc., preference statistics according to season and weather, etc., a new and enjoyable coffee experience can be provided to the user every time. Therefore, there is a need for a method and apparatus capable of encouraging users to create coffee recipes, sharing profits, and providing customized recommendations to other users.

When users can visit an offline store where a coffee will be served reproduced three-dimensionally through a metaverse, select an item from the menu, and have meetings with other users, the users can use time and space more efficiently and enjoy themselves in connection with actual offline visits. Therefore, there is a need for a method and apparatus capable of providing a coffee service on a metaverse platform that is linked to an actual user.

### RELATED ART DOCUMENT

### Patent Document

(Patent Document 0001) Korean Laid-open Patent Application No. 10-2011-0102129 (Published on Sep. 16, 2011) (Title: SYSTEM AND METHOD FOR LINKING ONLINE MEDIA SERVICE WITH ITS MATRIX MANAGEMENT)

### SUMMARY OF THE INVENTION

The present invention aims to solve the following objects in order to solve the above problems.

The present invention is directed to providing a method and apparatus for providing a user-customized coffee recipe and coffee corresponding to the same.

The present invention is also directed to providing a method and apparatus for providing a method of operating a server, through which one or more recommended recipes are provided to a user who requests a coffee on the basis of a plurality of coffee recipes provided by users participating in a service, the user watches an advertising video for a determined recipe of his/her choice, and then a quick response (QR) code that allows the user to receive a coffee of the determined recipe from a coffee shop associated with the server offline is provided, and a server device.

The present invention is also directed to providing a method and apparatus for enabling consumers to receive coffees based on their own recipes regardless of time and place.

The present invention is also directed to providing a method and apparatus capable of encouraging users to create coffee recipes, sharing profits, and providing customized recommendations to other users.

The present invention is also directed to providing a method and apparatus capable of providing a coffee service on a metaverse platform that is linked to an actual user.

Objects according to the technical spirit of the present invention are not limited to the above-described objects and other objects that are not described may be clearly understood by those skilled in the art from the following descriptions.

According to an aspect of the present invention, there is provided a method of operating a server in a communication system. The server includes a transceiver, a memory, and a processor. The method includes receiving, by the transceiver, a coffee request message including user identification information from a user terminal, selecting, by the processor, one or more recommended recipes from among a plurality of recipes stored in the memory on the basis of the user identification information, transmitting, by the transceiver, the one or more recommended recipes to the user terminal, receiving, by the transceiver, information on one determined recipe selected from among the one or more recommended recipes from the user terminal, transmitting, by the transceiver, information on one or more advertising videos among a plurality of advertising videos to the user terminal, receiving, by the transceiver, a message indicating completion of watching of the one or more advertising videos from the user terminal, transmitting, by the transceiver, information on a QR code that allows the determined recipe to be received to the user terminal, receiving from a coffee shop terminal, by the transceiver, a message indicating that the user terminal has input a QR code for the coffee shop terminal, and transmitting, by the transceiver, a coffee offer grant message including the information on the determined recipe to the coffee shop terminal, wherein each of the plurality of recipes includes at least one of a type of beans, a blending ratio of beans, a blending amount, an amount of water, and a coffee liquid extraction method.

According to another aspect of the present invention, there is provided a server in a communication system. The server includes a transceiver, a memory, and a processor, and the processor is configured to perform the method of operating the server in the communication system according to various embodiments of the present invention.

According to still another aspect of the present invention, there is provided a computer program recorded on a computer readable storage medium. The computer program is configured to perform the method of operating the server in the communication system according to various embodiments of the present invention.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 illustrates a communication system according to various embodiments of the present invention;

FIG. 2 is a block diagram illustrating a configuration of a user terminal and a coffee shop terminal according to various embodiments of the present invention;

FIG. 3 is a block diagram illustrating a configuration of a server according to various embodiments of the present invention;

FIG. 4 is a flowchart illustrating signals between a user terminal, a server, and a coffee shop terminal according to various embodiments of the present invention; and

FIG. 5 illustrates an operating process of a server according to various embodiments of the present invention.

### DETAILED DESCRIPTION OF EXEMPLARY EMBODIMENTS

Hereinafter, embodiments of the present invention that can be easily performed by those skilled in the art will be described in detail with reference to the accompanying drawings. The present invention may be implemented in several different forms and is not limited to embodiments described herein.

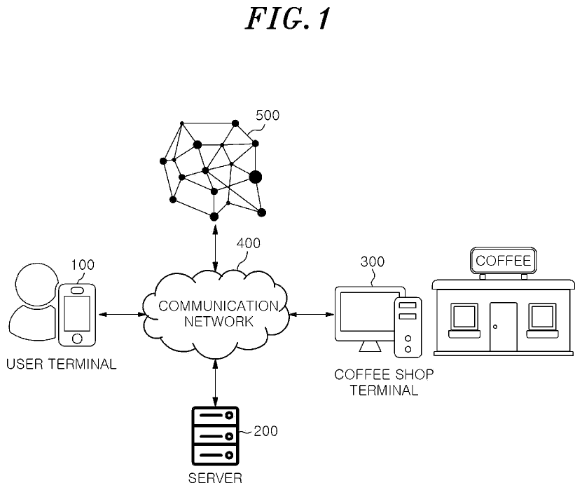

FIG. 1 illustrates a communication system according to various embodiments of the present invention.

Referring to FIG. 1, the communication system according to various embodiments of the present invention includes a user terminal 100, a server 200, a coffee shop terminal 300, a wired/wireless communication network 400, and a blockchain network 500.

The user terminal 100 is a terminal operated by a user of a user-customized coffee providing service. The user terminal 100 is an electronic device capable of exchanging information with the server 200 through the wired/wireless communication network 400. The user terminal 100 may be an electronic device including an input device capable of inputting information, such as a personal computer, a cellular phone, a smartphone, a tablet computer, or the like, an output device capable of outputting information, a memory capable of storing information, a transceiver capable of transmitting and receiving information, at least one processor capable of performing computation of information, and a camera capable of recognizing a quick response (QR) code.

The server 200 is a server operated by a coffee service provider based on user-customized recipes. The server 200 is an electronic device capable of exchanging information with the user terminal 100 and the coffee shop terminal 300 through the wired/wireless communication network 400. The server 200 may be an electronic device including a memory capable of storing information, a transceiver capable of transmitting and receiving information, and at least one processor capable of performing computation of information.

The coffee shop terminal 300 is a terminal which is connected to the server and operated by an operator of a coffee shop that can provide coffees based on user-customized recipes. The coffee shop terminal 300 may be an electronic device capable of exchanging information with the server 200 through the wired/wireless communication network 400. The coffee shop terminal 300 may be an electronic device including an input device capable of inputting information, such as a personal computer, a cellular phone, a smartphone, a tablet computer, or the like, an output device capable of outputting information, a memory capable of storing information, a transceiver capable of transmitting and receiving information, at least one processor capable of performing computation of information, and a camera capable of recognizing a QR code.

The wired/wireless communication network 400 provides a communication channel through which the user terminal 100, the server 200, and the coffee shop terminal 300 transmit or receive signals and data to or from each other. The wired/wireless communication network 400 is not limited to a communication method according to a specific communication protocol, and an appropriate communication method may be used according to an implementation example. For example, when the wired/wireless communication network 400 is configured as an Internet protocol (IP) based system, the wired/wireless communication network 400 may be implemented as a wired/wireless Internet, and when the user terminal 100, the server 200, and the coffee shop terminal 300 are implemented as mobile communication terminals, the wired/wireless communication network 400 may be implemented as a wireless network such as a cellular network or a wireless local area network (WLAN).

The blockchain network 500 includes a plurality of nodes operating based on a blockchain technology. Here, the blockchain technology is a distributed storage technology in which a storage structure in which blocks are connected in the form of a chain is used and data to be managed is stored in a plurality of nodes constituting a blockchain network. The blockchain network 500 may store a transaction transmitted from at least one of the nodes constituting the blockchain network, such as the user terminal 100, the server 200, and the coffee shop terminal 300, in the form of a block on the basis of a predetermined consensus algorithm. Data stored in the form of the block may be shared by the plurality of nodes constituting the blockchain network 500. Although the blockchain network 500 is represented as a separate entity in FIG. 1, according to various embodiments of the present invention, the blockchain network 500 may be implemented to be included in the server 200 (e.g., a lottery service providing server). The blockchain network 500 may include a public blockchain network in which arbitrary nodes can perform a consensus operation or a private blockchain network in which only predetermined nodes can perform a consensus operation according to the type of implementation.

The consensus algorithm performed by the blockchain network 500 according to various embodiments of the present invention may include a proof of work (PoW) algorithm, a proof of stake (PoS) algorithm, a delegated proof of stage (DPoS) algorithm, a practical byzantine fault tolerance (PBFT) algorithm, a delegated byzantine fault tolerance (DBFT) algorithm, a redundant byzantine fault tolerance (RBFT) algorithm, a sieve algorithm, a tendermint algorithm, a paxos algorithm, a raft algorithm, a proof of authority (PoA) algorithm, and/or a proof of elapsed time (PoET) algorithm.

According to various embodiments of the present invention, the nodes in the blockchain network 500 may be operated by a blockchain core package according to a hierarchical structure. The hierarchical structure may include a data layer that defines a structure of data handled in the blockchain network 500 and manages the data, a consensus layer responsible for validating blocks, performing mining to generate blocks, and processing fees paid to miners during the mining process, an execution layer that processes and executes smart contracts, a common layer that implements and manages peer-to-peer network protocols, hash functions, digital signatures, encodings, and common storage, and an application layer where various applications are generated, processed and managed.

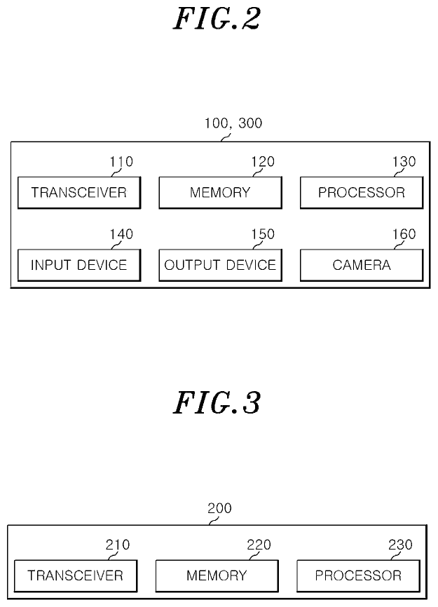

FIG. 2 is a block diagram illustrating a configuration of a user terminal and a coffee shop terminal according to various embodiments of the present invention.

Referring to FIG. 2, each of a user terminal 100 and a coffee shop terminal 300 according to various embodiments of the present invention includes a transceiver 110, a memory 120, a processor 130, an input device 140, an output device 150, and a camera 160.

The transceiver 110 is connected to the processor 130 and transmits and/or receives signals. All or part of the transceiver 110 is referred to as a transmitter, a receiver, or a transceiver. The transceiver 110 may support at least one of various wireless communication standards such as an Institute of Electrical and Electronics Engineers (IEEE) 802.xx system, an IEEE Wi-Fi system, a 3rd Generation Partnership Project (3GPP) system, a 3GPP Long-Term Evolution (LTE) system, a 3GPP 5^{th} generation (5G) New Radio (NR) system, a 3GPP2 system, Bluetooth, etc., which are wired access systems and wireless access systems. The transceiver 110 may support a wireless access system ranging from first generation (1G) to sixth generation (6G) of wireless networks. The transceiver 110 may support computer system operation using cloud computing technology.

The memory 120 is connected to the transceiver 110, the memory 120, the processor 130, the input device 140, and the output device 150 and may store information input through the input device 140, information received from the server 200 through communication of the transceiver 110, and the like. Further, the memory 120 is connected to the processor 130 and may store data such as basic programs for operation of the processor 130, application programs, setting information, information generated by operation of the processor 130, and the like. The memory 120 may be composed of a volatile memory, a non-volatile memory, or a combination of a volatile memory and a non-volatile memory. In addition, the memory 120 may provide stored data in response to a request of the processor 130.

The processor 130 may be configured to implement procedures and/or methods proposed in the present invention. The processor 130 controls overall operations of the user terminal 100 and/or the coffee shop terminal 300. For example, the processor 130 transmits or receives information and the like through the transceiver 110. Further, the processor 130 writes data to or reads data from the memory 120. Further, the processor 130 receives information through the input device 140. Further, the processor 130 outputs information through the output device 150. The processor 130 may include at least one processor.

The input device 140 is connected to the processor 130 and may input information and the like. According to an embodiment, the input device 140 may input information received from another device connected to the wired/wireless communication network 400 through the transceiver 110. The input device 140 may include a touch display, a keypad, a keyboard, or the like.

The output device 150 is connected to the processor 130 and may output information and the like in the form of video/audio. According to an embodiment, the output device 150 may output information and the like received from another device connected to the wired/wireless communication network 400 through the transceiver 110. The output device 150 may include a display, a speaker, or the like.

The camera 160 is connected to the processor 130 and may capture an image of a front object. According to various embodiments of the present invention, the camera 160 may be replaced with a barcode sensor capable of recognizing a front QR code. According to various embodiments of the present invention, the camera 160 may be replaced with at least one of an infrared sensor, an ultrasonic sensor, and various other sensors.

FIG. 3 is a block diagram illustrating a configuration of a server according to various embodiments of the present invention.

Referring to FIG. 3, a server 200 according to various embodiments of the present invention includes a transceiver 210, a memory 220, and a processor 230.

The transceiver 210 is connected to the processor 230 and transmits and/or receives signals. All or part of the transceiver 210 is referred to as a transmitter, a receiver, or a transceiver. The transceiver 210 may support at least one of various wireless communication standards such as an IEEE 802.xx system, an IEEE Wi-Fi system, a 3GPP system, a 3GPP LTE system, a 3GPP 5G NR system, a 3GPP2 system, Bluetooth, etc., which are wired access systems and wireless access systems. The transceiver 210 may support a wireless access system ranging from 1G to 6G of wireless networks. The transceiver 210 may support computer system operation using cloud computing technology.

The memory 220 is connected to the transceiver 210 and may store information received from a user terminal 100 or a coffee shop terminal 300 through communication of the transceiver 210. Further, the memory 220 is connected to the processor 230 and may store data such as basic programs for operation of the processor 230, application programs, setting information, information generated by operation of the processor 230, and the like. The memory 220 may be composed of a volatile memory, a non-volatile memory, or a combination of a volatile memory and a non-volatile memory. In addition, the memory 220 may provide stored data in response to a request of the processor 230.

The processor 230 may be configured to implement procedures and/or methods proposed in the present invention. The processor 230 controls overall operations of the server 200. For example, the processor 230 transmits or receives information and the like through the transceiver 210. Further, the processor 230 writes data to or reads data from the memory 220. The processor 230 may include at least one processor.

The technical features of the present invention may be summarized as follows.

1. User-customized coffee may be provided.

2. A user-customized coffee service may be provided through a smartphone app.

(2-1) Find and select a coffee shop or a coffee vending machine on a map in the app=>select a recipe=>watch an advertisement=>receive a generated QR code=>move to the coffee shop or the coffee vending machine=>scan the QR code=>receive a desired coffee (service)

(2-2) All related information such as user information, recipe information, eligibility for service, etc. may be included in the QR code.

(2-3) The recipe may be selected from among a recipe pre-registered by a user himself/herself, popular recipes, recommended recipes, and the like.

(2-4) The user may add or subtract a specific item to or from the existing recipes.

3. Application of artificial intelligence (AI) and big data

(3-1) A new recipe may be recommended by analyzing the recipes that the user enjoys drinking.

(3-2) New trend recipes by country and region may be recommended.

(3-3) Popular recipes according to age and sex may be recommended.

(3-4) Recipes according to season and weather may be recommended.

(3-5) User-customized healthy recipes may be recommended through big data (usage performance) analysis.

(3-6) An appropriate recipe according to the life cycle may be recommended as the user's age changes.

(3-7) By analyzing the content of responses to questions within advertisements, users' interests may be managed as big data and appropriate information may be provided to advertisers and users.

(3-8) It is possible to induce users to participate in the service of a certain company and improve their satisfaction by providing various pieces of information in a timely manner through life cycle management.

4. Provision of services that link metaverse platform

(4-1) It is possible to provide a linked service for holding a meeting to exchange messages with other users in a store in the virtual world of a metaverse, which is a three-dimensional representation of a store in the real world, by applying metaverse technology.

(4-2) Within a metaverse platform, various services such as coffee plantation tours, coffee branding company visits, and the like may be provided.

(4-3) Recipe contests, coffee story contests, and the like may be held, and the server operator may recognize/announce the creation rights of a winning recipe/participating recipe and provide incentives from the profits earned from the recipe.

(4-4) Creation and provision of recipes may be encouraged by providing incentives (gifts) to participants as well.

(4-5) Coffee lectures, roasting lectures, and the like may be provided through the metaverse platform.

(4-6) It is possible to provide services that allow users to study the history of coffee, the cultivation process, distribution routes, and the like through the metaverse platform.

5. Blockchain application

(5-1) The creation right of the recipe of the user who wins the recipe contest is recognized and usage fees/incentives for recipes are paid for a certain period of time, and thus a win-win model may be provided between the company and the user.

(5-2) In addition to contests, when other users use the coffee made according to the recipe created by the user, incentives may be provided to the creator of the recipe.

(5-3) The recipe may be protected from being stolen by others (registered as their recipe) by the creation of the recipe being announced through blockchain technology.

(5-4) Cryptocurrency (coin) combination

(5-4-a) Coins accumulated through revenues from advertisements watched to receive coffee, various reward programs obtained from recipe creation, incentives, and the like may be used to pay for coffee and other services.

(5-4-c) By providing the ability to mine coins by watching advertisements to receive coffee and creating recipes, investment opportunities through virtual asset mining are provided, and mined virtual assets may be used for payment for coffee and other services as a means of transaction within the platform.

(5-4-c) Coins earned may be used with merchants, affiliates, and online services associated with service providers anywhere in the world.

6. Dissemination of home appliances

(6-1) By supplying home appliances associated with the service platform, customized services may be provided to users at home or at work.

(6-2) The production and distribution of devices may be promoted so that anyone can do it through a method certified by the company.

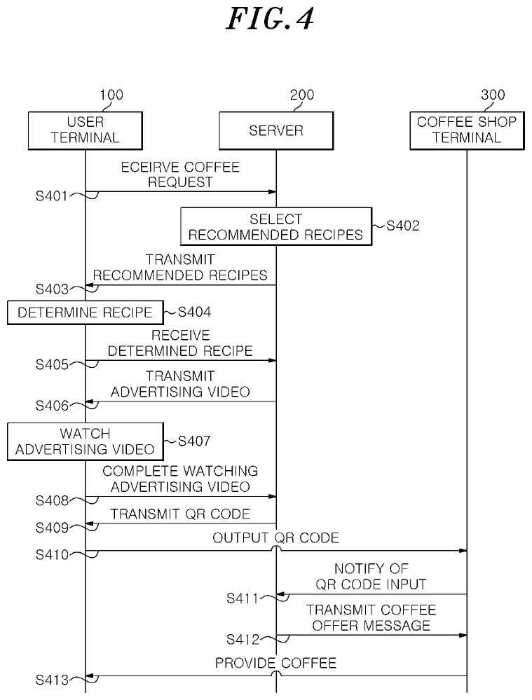

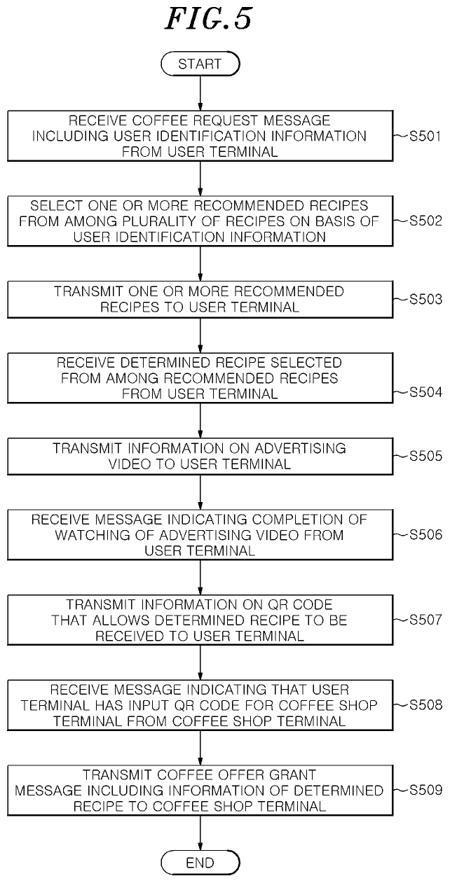

FIG. 4 is a flowchart illustrating signals between a user terminal, a server, and a coffee shop terminal according to various embodiments of the present invention.

Referring to FIG. 4, in operation S401, the server receives a coffee request message including user identification information from a user.

In operation S402, the server selects one or more recommended recipes from among a plurality of recipes on the basis of the user identification information.

In operation S403, the server transmits the one or more recommended recipes to the user terminal.

In operation S404, the user terminal outputs the received one or more recommended recipes using an output device, and receives an input about selection of one determined recipe from among the one or more recommended recipes using an input device.

In operation S405, the server receives information on the one determined recipe among the one or more recommended recipes from the user terminal.

In operation S406, the server transmits information on one or more advertising videos among a plurality of advertising videos to the user terminal. The information on the plurality of advertising videos is information that the server has previously received from an advertiser terminal. The server may receive a cost corresponding to the exposure of the advertisement from the advertiser terminal as revenue in return for providing the advertising video to the user terminal.

In operation S407, the user terminal outputs the received information on the one or more advertising videos using the output device. The user terminal proceeds to operation S408 after a minimum watching time set for the advertising video has elapsed.

In operation S408, the server receives a message indicating completion of watching of the one or more advertising videos from the user terminal.

In operation S409, the server generates information on a QR code that allows the determined recipe to be received, and transmits the information on the QR code to the user terminal.

In operation S410, the user terminal outputs the QR code received in operation S409 using the output device, and inputs the QR code for a camera or barcode sensor of a coffee shop terminal.

In operation S411, regarding information on the QR code input by the camera or barcode sensor of the coffee shop terminal, the coffee shop terminal transmits a message indicating input of the QR code to the server.

In operation S412, the server determines whether the QR code received from the coffee shop terminal in operation S411 matches the QR code transmitted to the user terminal in operation S409, and transmits a coffee offer grant message including information of the determined recipe to the coffee shop terminal.

In operation S413, the coffee shop terminal transmits a coffee offer message to the user terminal and performs an operation for providing a coffee to the user. The coffee shop terminal may output the information on the determined recipe so that a barista in the coffee shop can view the information on the determined recipe. When there is a coffee making device capable of automatically roasting and blending coffee beans from green coffee beans in the coffee shop, that is, a coffee machine, the coffee shop terminal may transmit a control signal for making coffee according to the determined recipe to the coffee making device, that is, the coffee machine.

FIG. 5 illustrates an operating process of a server according to various embodiments of the present invention.

In an embodiment of FIG. 5, a server includes a transceiver, a memory, and a processor.

Referring to FIG. 5, in operation S501, the server receives a coffee request message including user identification information from the user terminal through the transceiver.

In operation S502, the server selects one or more recommended recipes from among a plurality of recipes stored in the memory on the basis of the user identification information through the processor. Each of the plurality of recipes includes at least one of a type of beans, a blending ratio of beans, a blending amount, an amount of water, and a coffee liquid extraction method.

In operation S503, the server transmits the one or more recommended recipes to the user terminal through the transceiver.

In operation S504, the server receives information on one determined recipe selected from among the one or more recommended recipes from the user terminal through the transceiver.

In operation S505, the server transmits information on one or more advertising videos among a plurality of advertising videos to the user terminal through the transceiver.

In operation S506, the server receives a message indicating completion of watching of the one or more advertising videos from the user terminal through the transceiver.

In operation S507, the server transmits information on a QR code that allows the determined recipe to be received to the user terminal through the transceiver.

In operation S508, the server receives a message indicating that the user terminal has input a QR code for a coffee shop terminal from the coffee shop terminal through the transceiver.

In operation S509, the server transmits a coffee offer grant message including information of the determined recipe to the coffee shop terminal through the transceiver.

According to various embodiments of the present invention, the embodiment of FIG. 5 may further include receiving, by the transceiver, information on a newly created coffee recipe from the user terminal, verifying, by the processor, whether the information on the newly created coffee recipe is a new recipe that does not exist in the plurality of recipes stored in the memory, when it is verified that the information on the newly created coffee recipe is a new recipe, adding, by the processor, the information on the newly created coffee recipe to the information on the plurality of recipes stored in the memory, and transmitting, by the transceiver, reward information for the addition of the newly created coffee recipe to the user terminal. The plurality of recipes include newly created coffee recipes received from a plurality of user terminals connected to the server.

According to various embodiments of the present invention, the receiving, by the transceiver, of the information on the newly created coffee recipe from the user terminal may include receiving new temporary recipe information including at least one of a type of beans, a blending ratio of beans, a blending amount, an amount of water, and a coffee liquid extraction method from the user terminal, generating information on predicted taste on the basis of the new temporary recipe information, transmitting information on the predicted taste to the user terminal, receiving test cost information and a test request for the new temporary recipe information from the user terminal, wherein the test cost information includes one of test cost payment information of the user terminal, coupon payment information of the user terminal, or coin payment information of the user terminal, transmitting a second QR code of a taste testing request for the new temporary recipe information without an advertising video to a random second user terminal in response to the test request, receiving from a second coffee shop terminal connected to the server, by the transceiver, a message indicating that the second user terminal has input the second QR code for the second coffee shop terminal, transmitting, by the transceiver, a coffee offer grant message including the new temporary recipe information to the second coffee shop terminal, receiving a taste evaluation message for the new temporary recipe information from the second user terminal within a set time after transmitting the coffee offer grant message including the new temporary recipe information, transmitting reward information for the taste evaluation message to the second user terminal, transmitting the taste evaluation message to the user terminal, and receiving, by the transceiver, the information on the newly created coffee recipe corresponding to the new temporary recipe information from the user terminal.

According to various embodiments of the present invention, the embodiment of FIG. 5 may further include generating recipe preference statistical information based on information of users who have selected a determined recipe for each of the plurality of recipes, wherein the recipe preference statistical information includes sex information, age information, country information, detailed information on a region, information on a season, and information on weather for users who have selected a determined recipe for each of the plurality of recipes. The selection, by the processor, of the one or more recommended recipes from among the plurality of recipes stored in the memory on the basis of the user identification information is performed based on the mapping of the user identification information to the recipe preference statistical information. The user identification information includes sex information, age information, country information, detailed information on a region from which the user transmitted the coffee request message, information on the season in which the user transmitted the coffee request message, and information on the weather when the user transmitted the coffee request message, of users. The one or more recommended recipes include one or more recipes similar to history of the previously received determined recipes from the user terminal, and one or more recipes selected based on the mapping of the user identification information to the recipe preference statistical information. Ratios of the one or more recipes similar to the history and the one or more recipes selected based on the mapping of the user identification information, among the one or more recommended recipes, are based on set ratios.

According to various embodiments of the present invention, the embodiment of FIG. 5 may further include transmitting, by the transceiver, a survey question message related to the one or more advertising videos together with the one or more advertising videos to the user terminal, upon receiving a response message to the survey question message together with a message indicating the completion of watching of the one or more advertising videos from the user terminal, adding, by the transceiver, an option of a size increase, a coffee menu item change, or a dessert addition to the information of the QR code and transmitting the information to the user terminal, and transmitting, by the transceiver, the response message and some of the user identification information to an advertiser terminal related to the response message.

According to various embodiments of the present invention, the embodiment of FIG. 5 may further include receiving, by the transceiver, a request message for metaverse coffee shop information together with information on a coffee shop selected from among a plurality of coffee shops connected to the server from the user terminal, and transmitting, by the transceiver, the metaverse coffee shop information in which an actual coffee shop corresponding to the information of the selected coffee shop is three-dimensionally implemented, to the user terminal. The transmitting, by the transceiver, of the one or more recommended recipes to the user terminal is performed by transmitting, by the transceiver, a description of the one or more recommended recipes together with an image of coffee corresponding to the one or more recommended recipes to an avatar corresponding to the user terminal in the metaverse coffee shop to the user terminal. The metaverse coffee shop is configured to perform a meeting in which conversations are exchanged with other user terminals in the metaverse coffee shop.

According to various embodiments of the present invention, the embodiment of FIG. 5 may further include receiving a coffee request message in which a determined recipe for a newly created coffee recipe is selected from a plurality of other user terminals, and transmitting reward information based on the number of coffee request messages in which the determined recipe is selected for the newly created coffee recipe to the user terminal. The reward information based on the number of coffee request messages is based on a set ratio of the advertising revenue of the advertising video corresponding to the coffee request message in which the determined recipe is selected for the newly created coffee recipe. The set ratio is set higher as the ratio of the determined recipes determined as the newly created coffee recipes among all the determined recipes received by the server during a unit period is higher.

According to various embodiments of the present invention, the embodiment of FIG. 5 may further include transmitting, by the transceiver, information of the newly created coffee recipe and information of a user who provided the information of the newly created coffee recipe to a shared ledger of a blockchain network, and transmitting information on a reward coin to an electronic wallet corresponding to the user terminal in response to the information of the newly created coffee recipe.

Various embodiments of the present invention provide a server in a communication system. The server includes a transceiver, a memory, and a processor, and the processor is configured to perform the method of operating the server in the communication system according to various embodiments of the present invention.

Various embodiments of the present invention provide a computer program recorded on a computer readable storage medium. The computer program is configured to perform the method of operating the server in the communication system according to various embodiments of the present invention.

In the case of implementing the embodiments of the present invention using hardware, application specific integrated circuits (ASICs), digital signal processors (DSPs), digital signal processing devices (DSPDs), programmable logic devices (PLDs), field programmable gate arrays (FPGAs), and the like which are configured to perform the present invention may be provided in the processor of the present invention.

Meanwhile, the above-described method may be written as a program that can be executed on a computer, and can be implemented in a general-purpose digital computer that operates the program using a computer-readable medium. Further, a structure of data used in the above-described method may be recorded on a computer-readable storage medium through various means. Program storage devices, which may be used to describe a storage device containing executable computer code for performing various methods of the present invention, should not be construed as including transitory objects such as carrier waves or signals. Computer-readable storage media include storage media such as magnetic storage media (e.g., a read only memory (ROM), a floppy disk, a hard disk, etc.) and optical reading media (e.g., a compact disc read only memory (CD-ROM), a digital video disc (DVD), etc.).

The embodiments described above are those in which components and features of the present invention are combined in a predetermined form. Each component or feature should be considered optional unless explicitly stated otherwise. Each component or feature may be implemented in a form not combined with other components or features. In addition, it is also possible to configure an embodiment of the present invention by combining some components and/or features. The order of operations described in the embodiments of the present invention may be changed. Some components or features of one embodiment may be included in another embodiment, or may be replaced with corresponding components or features of another embodiment. It is obvious that claims that do not have an explicit citation relationship in the claims can be combined to form an embodiment or can be included as new claims by amendment after filing.

The present invention can provide a method and apparatus for providing a user-customized coffee recipe and coffee corresponding to the same.

The present invention can provide method of operating a server, through which one or more recommended recipes are provided to a user who requests a coffee on the basis of a plurality of coffee recipes provided by users participating in a service, the user watches an advertising video for a determined recipe of his/her choice, and then a QR code that allows the user to receive the coffee of the determined recipe from a coffee shop associated with the server offline is provided, and a server device.

The present invention can provide a method and apparatus for enabling consumers to receive coffees based on their own recipes regardless of time and place.

The present invention can provide a method and apparatus capable of encouraging users to create coffee recipes, sharing profits, and providing customized recommendations to other users.

The present invention can provide a method and apparatus capable of providing a coffee service on a metaverse platform that is linked to an actual user.

It will be clear to those skilled in the art that the present invention can be embodied in other forms without departing from the technical spirit and essential characteristics of the present invention. Accordingly, the above embodiments should be considered in all respects as illustrative rather than restrictive. The scope of the present invention should be determined by reasonable interpretation of the appended claims and all possible changes within the equivalent scope of the present invention.

What is claimed is:

1. A method of operating a server including a transceiver, a memory, and a processor in a communication system, the method comprising:
receiving, by the transceiver, a coffee request message including user identification information from a user terminal;
selecting, by the processor, one or more recommended recipes from among a plurality of recipes stored in the memory on the basis of the user identification information, wherein the user identification information includes an age of a user corresponding to the user terminal, and information on a season and weather of a region in which the user terminal is used, the one or more recommended recipes include healthy recipes according to a life cycle according to the user's age, and the one or more recommended recipes further include recipes based on recipe preference statistical information of the plurality of users according to season and weather;
transmitting, by the transceiver, the one or more recommended recipes to the user terminal;
receiving, by the transceiver, information on one determined recipe selected from among the one or more recommended recipes from the user terminal;
transmitting, by the transceiver, information on one or more advertising videos among a plurality of advertising videos to the user terminal;
receiving, by the transceiver, a message indicating completion of watching of the one or more advertising videos from the user terminal;
transmitting, by the transceiver, information on a quick response (QR) code that allows the determined recipe to be received to the user terminal;
receiving from a coffee shop terminal, by the transceiver, a message indicating that the user terminal has input a QR code for the coffee shop terminal; and
transmitting, by the transceiver, a coffee offer grant message including the information on the determined recipe to the coffee shop terminal,
wherein each of the plurality of recipes includes at least one of a type of beans, a blending ratio of beans, a blending amount, an amount of water, and a coffee liquid extraction method,
the method further includes receiving, by the transceiver, information on a newly created coffee recipe from the user terminal,
verifying, by the processor, whether the information on the newly created coffee recipe is a new recipe that does not exist in the plurality of recipes stored in the memory,
when it is verified that the information on the newly created coffee recipe is a new recipe, adding, by the processor, the information on the newly created coffee recipe to the information on the plurality of recipes stored in the memory, and
transmitting, by the transceiver, reward information for the addition of the newly created coffee recipe to the user terminal, and
wherein the plurality of recipes include newly created coffee recipes received from a plurality of user terminals connected to the server,
the receiving, by the transceiver, of the information on the newly created coffee recipe from the user terminal includes receiving new temporary recipe information including at least one of a type of beans, a blending ratio of beans, a blending amount, an amount of water, and a coffee liquid extraction method from the user terminal,
generating information on predicted taste on the basis of the new temporary recipe information,
transmitting information on the predicted taste to the user terminal,
receiving test cost information and a test request for the new temporary recipe information from the user terminal, wherein the test cost information includes one of test cost payment information of the user terminal, coupon payment information of the user terminal, or coin payment information of the user terminal,
transmitting a second QR code of a taste testing request for the new temporary recipe information without an advertising video to a random second user terminal in response to the test request,
receiving from a second coffee shop terminal connected to the server, by the transceiver, a message indicating that the second user terminal has input the second QR code for the second coffee shop terminal,
transmitting, by the transceiver, a coffee offer grant message including the new temporary recipe information to the second coffee shop terminal,
receiving a taste evaluation message for the new temporary recipe information from the second user terminal within a set time after transmitting the coffee offer grant message including the new temporary recipe information,
transmitting reward information for the taste evaluation message to the second user terminal,
transmitting the taste evaluation message to the user terminal, and
receiving, by the transceiver, the information on the newly created coffee recipe corresponding to the new temporary recipe information from the user terminal.

2. The method of claim 1, further comprising generating recipe preference statistical information based on information of users who have selected a determined recipe for each of the plurality of recipes, wherein the recipe preference statistical information includes sex information, age information, country information, detailed information on a region, information on a season, and information on weather for users who have selected a determined recipe for each of the plurality of recipes,
the selecting, by the processor, of the one or more recommended recipes from among the plurality of recipes stored in the memory on the basis of the user identification information is performed based on the mapping of the user identification information to the recipe preference statistical information,
the user identification information includes sex information, age information, country information, detailed information on a region from which the user transmitted the coffee request message, information on a season in which the user transmitted the coffee request message, and information on weather when the user transmitted the coffee request message, for users,
the one or more recommended recipes include one or more recipes similar to the history of previously received determined recipes from the user terminal, and one or more recipes selected based on the mapping of the user identification information to the recipe preference statistical information, and
ratios of the one or more recipes similar to the history and the one or more recipes selected based on the mapping of the user identification information, among the one or more recommended recipes, are based on set ratios.

3. The method of claim 1, further comprising:
transmitting, by the transceiver, a survey question message related to the one or more advertising videos together with the one or more advertising videos to the user terminal;
upon receiving a response message to the survey question message together with a message indicating the completion of watching of the one or more advertising videos from the user terminal, adding, by the transceiver, an option of a size increase, a coffee menu item change, or a dessert addition to the information of the QR code and transmitting the information to the user terminal; and
transmitting, by the transceiver, the response message and some of the user identification information to an advertiser terminal related to the response message.

4. The method of claim 1, further comprising:
receiving, by the transceiver, a request message for metaverse coffee shop information together with information on a coffee shop selected from among a plurality of coffee shops connected to the server from the user terminal; and
transmitting, by the transceiver metaverse, the metaverse coffee shop information in which an actual coffee shop corresponding to the information of the selected coffee shop is three-dimensionally implemented, to the user terminal,
wherein the transmitting, by the transceiver, of the one or more recommended recipes to the user terminal is performed by transmitting, by the transceiver, a description of the one or more recommended recipes together with an image of coffee corresponding to the one or more recommended recipes to an avatar corresponding to the user terminal in the metaverse coffee shop to the user terminal, and
the metaverse coffee shop is configured to perform a meeting in which conversations are exchanged with other user terminals in the metaverse coffee shop.

5. The method of claim 1, further comprising:
receiving a coffee request message in which a determined recipe for a newly created coffee recipe is selected from a plurality of other user terminals; and
transmitting reward information based on the number of coffee request messages in which the determined recipe is selected for the newly created coffee recipe to the user terminal,
wherein the reward information based on the number of coffee request messages is based on a set ratio of the advertising revenue of the advertising video corresponding to the coffee request message in which the determined recipe is selected for the newly created coffee recipe, and
the set ratio is set higher as the ratio of the determined recipes determined as the newly created coffee recipes among all the determined recipes received by the server during a unit period is higher.

6. The method of claim 1, further comprising:
transmitting, by the transceiver, information of the newly created coffee recipe and information of a user who provided the information of the newly created coffee recipe to a shared ledger of a blockchain network; and
transmitting information on a reward coin to an electronic wallet corresponding to the user terminal in response to the information of the newly created coffee recipe.

7. A server in a communication system, comprising a transceiver, a memory, and a processor,
wherein the processor is configured to perform the method according to claim 1.

8. A computer readable storage medium in which a computer program is recorded and is configured to perform the method according to claim 1.
